(19) United States
(12) Patent Application Publication
(10) Pub. No.: US 2021/0404720 A1
(43) Pub. Date: Dec. 30, 2021

(54) FOIL BEARING LUBRICATION

(71) Applicant: Carrier Corporation, Palm Beach Gardens, FL (US)

(72) Inventors: Vishnu M. Sishtla, Manlius, NY (US); Yifan Qiu, Manlius, NY (US)

(21) Appl. No.: 17/303,963

(22) Filed: Jun. 11, 2021

Related U.S. Application Data
(60) Provisional application No. 62/705,372, filed on Jun. 24, 2020.

(51) Int. Cl. F25B 49/02; F25B 31/02; F25B 29/00; F25B 31/00

(52) U.S. Cl. CPC F25B 49/022; F25B 31/026; F25B 29/003; F25B 2700/21155; F25B 2400/01; F25B 2500/26; F25B 2700/21151; F25B 31/002

(57) ABSTRACT

A compressor assembly, a vapor compression system incorporating the same, and a method for operating the vapor compression system are provided. The compressor assembly includes a motor for driving a rotating shaft, a foil bearing for supporting the rotating shaft, a compression mechanism for increasing the pressure of a working fluid, a supply line in fluid communication with the compression mechanism, and a heating apparatus for heating the working fluid. The supply line is configured for injecting the working fluid (e.g., from downstream of the compression mechanism) toward the foil bearing. The method provides for the monitoring of the temperature of the working fluid. When the temperature of the working fluid is less than 3° F. of superheat it is heated prior to being injected toward the foil bearing. The heating of the working fluid prevents, or at least mitigates, liquid from being transferred to the foil bearing.

### CROSS REFERENCE TO A RELATED APPLICATION

The application claims the benefit of U.S. Provisional Application No. 62/705,372 filed Jun. 24, 2020, the contents of which are hereby incorporated in their entirety.

### BACKGROUND

Vapor compression systems (e.g., chillers) commonly include at least one compressor, a condenser, an expansion valve, and an evaporator. Refrigerant circulates through the vapor compression system in order to provide cooling to a medium (e.g., air). The refrigerant exits the compressor(s) through the discharge port(s) at a high pressure and a high enthalpy. The refrigerant then flows through the condenser at a high pressure and rejects heat to an external fluid medium. The refrigerant then flows through the expansion valve, which expands the refrigerant to a low pressure. After expansion, the refrigerant flows through the evaporator and absorbs heat from another medium (e.g., air). The refrigerant then re-enters the compressor(s) through the suction port(s), completing the cycle.

Compressors commonly include a motor rotor and a motor stator housed within a compressor housing. The rotor is fixed to and rotates with a rotating shaft, and the stator is fixed inside the compressor housing. Depending on the type of compressor, magnetic bearings or foil bearings may be used to support the rotating shaft while the compressor is operational. Magnetic bearings use electromagnets to levitate the rotating shaft. Foil bearings use pressurized gas to support the rotating shaft. Foil bearings have various advantages over magnetic bearings. For example, foil bearings can operate without the need for an external power supply or complicated control system, which, in turn, makes the foil bearings cheaper and less complex relative to the magnetic bearings.

When incorporated in a heating, ventilation, and air conditioning (HVAC) system, the pressurized gas used by the foil bearings may be working fluid (e.g., refrigerant) from the HVAC system. For example, when the HVAC system is operational, refrigerant in a predominately vapor state may be transferred from the HVAC system to the foil bearings. However, due to the low clearances and tolerances inherent in foil bearing design and assembly, if any of the refrigerant is left in a liquid state when transferred to the foil bearings the foil bearings may become damaged.

Accordingly, there remains a need for a way to prevent or at least mitigate any proportion of the working fluid from remaining in a liquid state when entering the foil bearings.

### BRIEF DESCRIPTION

According to one embodiment, a compressor assembly including a motor, a foil bearing, a compression mechanism, a supply line, and a heating apparatus is provided. The motor is used for driving a rotating shaft. The foil bearing is used for supporting the rotating shaft. The compression mechanism is used for increasing a pressure of a working fluid. The compression mechanism is connected to the rotating shaft. The supply line is in fluid communication with the compression mechanism. The supply line is configured for injecting the working fluid toward the foil bearing when the compressor is operational. The heating apparatus is in fluid communication with the supply line. The heating apparatus is configured to heat the working fluid prior to being injected toward the foil bearing.

In accordance with additional or alternative embodiments, the supply line is configured downstream of the compression mechanism.

In accordance with additional or alternative embodiments, the compressor assembly further includes at least one sensor disposed in the supply line upstream of the heating apparatus, the at least one sensor configured to monitor a temperature of the working fluid.

In accordance with additional or alternative embodiments, the heating apparatus is configured to heat the working fluid between 3° F. and 7° F. of superheat.

In accordance with additional or alternative embodiments, the heating apparatus includes at least one of: an external heater, the motor, a condenser, and a discharge gas conduit.

In accordance with additional or alternative embodiments, the working fluid includes a refrigerant.

According to another aspect of the disclosure, a vapor compression system including a condenser and a compressor assembly is provided. The condenser is used for transferring heat from a working fluid to an external fluid medium. The compressor assembly is in fluid communication with the condenser. The compressor assembly includes a motor, a foil bearing, a compression mechanism, a supply line, and a heating apparatus. The motor is used for driving a rotating shaft. The foil bearing is used for supporting the rotating shaft. The compression mechanism is used for increasing a pressure of a working fluid. The compression mechanism is connected to the rotating shaft. The supply line is in fluid communication with the compression mechanism. The supply line is configured for injecting the working fluid toward the foil bearing when the compressor is operational. The heating apparatus is in fluid communication with the supply line. The heating apparatus is configured to heat the working fluid prior to being injected toward the foil bearing.

In accordance with additional or alternative embodiments, the vapor compression system further includes at least one sensor disposed in the supply line upstream of the heating apparatus, the at least one sensor configured to monitor a temperature of the working fluid.

In accordance with additional or alternative embodiments, the working fluid is heated only when the working fluid has less than 3° F. of superheat.

The vapor compression system of claim 7, wherein the supply line is configured downstream of the compression mechanism.

The vapor compression system of claim 7, wherein the heating apparatus is configured to heat the working fluid between 3° F. and 7° F. of superheat.

In accordance with additional or alternative embodiments, the heating apparatus includes at least one of: an external heater, the motor, the condenser, and a discharge gas conduit.

In accordance with additional or alternative embodiments, the external fluid medium includes at least one of: an air supply and a water supply.

In accordance with additional or alternative embodiments, the working fluid includes a refrigerant.

According to another aspect of the disclosure, a method of operating a vapor compression system including a compressor and a condenser is provided. The compressor including a foil bearing for supporting a rotating shaft and a compression mechanism for increasing a pressure of a working fluid. The method includes a step for monitoring a temperature of the working fluid downstream of the compression mechanism. The method includes a step for injecting at least a portion of the working fluid from the compression mechanism toward the foil bearing, wherein the working fluid is heated prior to being injected toward the foil being when the working fluid has less than 3° F. of superheat.

In accordance with additional or alternative embodiments, the method further provides for injecting the working fluid approximately continuously from the compression mechanism.

In accordance with additional or alternative embodiments, the method further provides for heating the working fluid between 3° F. and 7° F. of superheat.

In accordance with additional or alternative embodiments, the method further provides for heating the working fluid with at least one of: an external heater, the motor, the condenser, and a discharge gas conduit.

In accordance with additional or alternative embodiments, the working fluid has between 1% and 5% liquid prior to being heated.

In accordance with additional or alternative embodiments, the working fluid includes a refrigerant.

### BRIEF DESCRIPTION OF THE DRAWINGS

The subject matter, which is regarded as the disclosure, is particularly pointed out and distinctly claimed in the claims at the conclusion of the specification. The following descriptions of the drawings should not be considered limiting in any way. With reference to the accompanying drawings, like elements are numbered alike:

FIG. 1 is a cross-sectional side view of a compressor depicting the injection of a working fluid toward a foil bearing, in accordance with one aspect of the disclosure.

FIG. 2 is a schematic illustration of a vapor compression system including a compressor and a condenser, with a supply line directing working fluid from a compression mechanism (e.g., an impeller) toward a foil bearing, where the working fluid is heated using an external heater, in accordance with one aspect of the disclosure.

FIG. 3 is a schematic illustration of a vapor compression system including a compressor and a condenser, with a supply line directing working fluid from a compression mechanism (e.g., an impeller) toward a foil bearing, where the working fluid is heated using the motor, in accordance with one aspect of the disclosure.

FIG. 4 is a schematic illustration of a vapor compression system including a compressor and a condenser, with a supply line directing working fluid from a compression mechanism (e.g., an impeller) toward a foil bearing, where the working fluid is heated using the condenser, in accordance with one aspect of the disclosure.

FIG. 5 is a schematic illustration of a vapor compression system including a compressor, a condenser, and an economizer, with a supply line directing working fluid from a compression mechanism (e.g., an impeller) toward a foil bearing, where the working fluid is heated using a discharge gas conduit, in accordance with one aspect of the disclosure.

FIG. 6 is a flow diagram illustrating a method of operating a vapor compression system including a compressor and a condenser, in accordance with one aspect of the disclosure.

### DETAILED DESCRIPTION

As will be described below, a compressor with a supply line for injecting a working fluid (e.g., a refrigerant) toward the foil bearing(s) within the compressor, and a vapor compression system incorporating the same are provided. The foil bearing(s), commonly referred to as radial bearings or thrust bearings, described herein may be interpreted to include any hydrodynamic bearing(s) capable of utilizing a gas/vapor to support a rotating shaft of a compressor. As described below, the gas/vapor used by the foil bearing(s) may be working fluid from the compressor. For example, the foil bearing(s) may support the rotating shaft of the compressor by using a portion of the working fluid that is being pressurized by the compressor. The working fluid, in certain instances, is heated before being injected toward the foil bearing(s). The heating of the working fluid may make it possible to prevent, or at least mitigate, any proportion of the working fluid from remaining in a liquid state when entering the foil bearing(s), which may help reduce the likelihood of the foil bearing(s) becoming damaged.

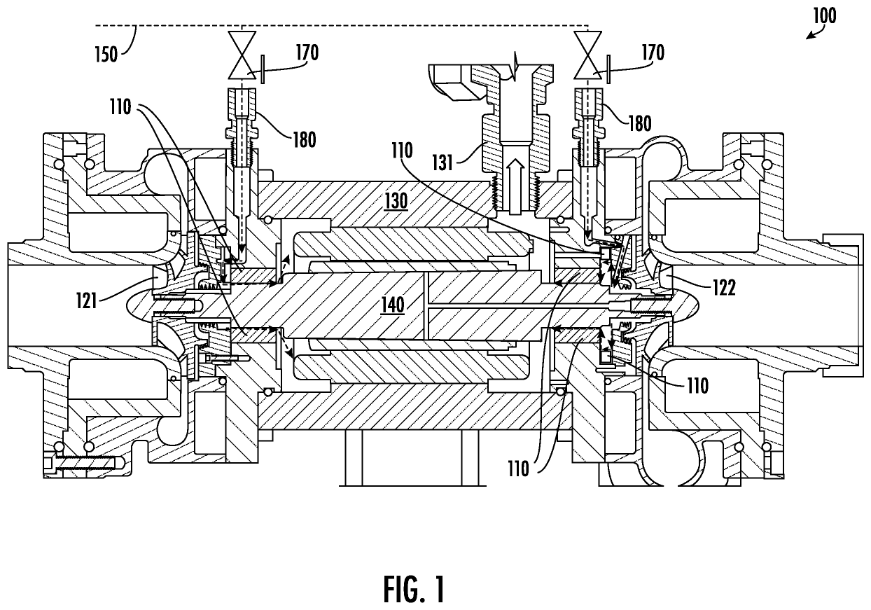

With reference now to the Figures, a cross-sectional side view of a compressor 100 illustrating the injection of a working fluid toward a foil bearing 110 is shown in FIG. 1. As shown in FIG. 1, the compressor 100 includes a motor 130, at least one foil bearing 110, a compression mechanism 121, and a supply line 150. It should be appreciated that the compression mechanism 121 may, in certain instances, be an impeller. As shown in FIG. 1, the compressor 100 may, in certain instances, be a two-stage compressor (e.g., including both a first compression mechanism 121 and a second compression mechanism 122). The motor 130 is used for driving a rotating shaft 140. The foil bearing 110 is used for supporting the rotating shaft 140. The compression mechanism 121 is used for increasing a pressure of a working fluid. The compression mechanism 121 is connected to the rotating shaft 140. The supply line 150 is in fluid communication with the compression mechanism 121. The supply line 150 is used for injecting a working fluid (e.g., through one or more nozzle 180) toward the foil bearing(s) 110. To avoid any proportion of the working fluid remaining in a liquid state, the working fluid may be heated prior to being injected toward the foil bearing(s) 110, as later described herein.

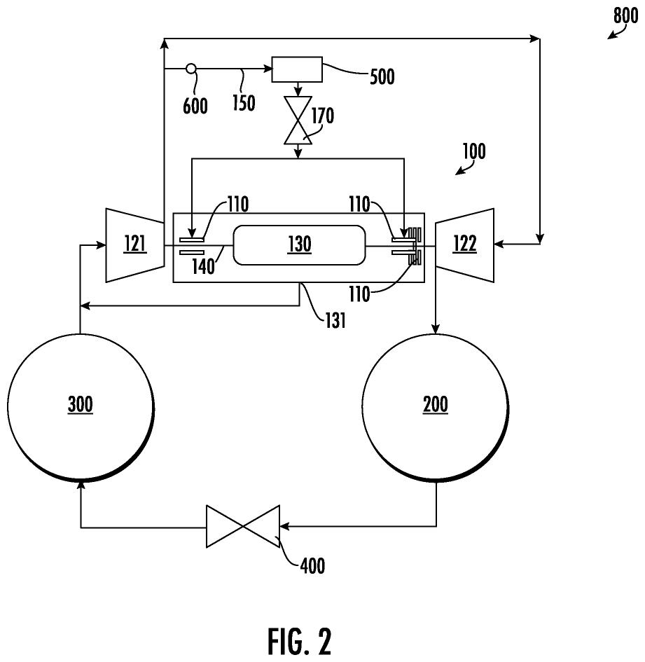

As shown in FIGS. 2-5, the compressor 100 may be one component of a vapor compression system 800. The vapor compression system 800 may include a compressor 100, a condenser 200, an expansion valve 400, and an evaporator 300. In some embodiments, the compressor 100 is either a centrifugal compressor, an axial compressor, a scroll compressor, or a screw compressor. The vapor compression system 800 may be configured to circulate working fluid (e.g., refrigerant, such as R-134A) through the vapor compression system 800 to provide cooling to a medium (e.g., air, water, etc.). It will be appreciated that other types of refrigerant may be used. As shown in FIGS. 2-5, the working fluid being injected toward the foil bearing(s) 110 of the compressor 100 may be provided from downstream of the compression mechanism 121. From downstream of the compression mechanism 121 may be interpreted to mean that the supply line 150 may be configured downstream of the compression mechanism 121 so as to withdraw working fluid after the working fluid exits the compression mechanism 121 (e.g., outside of the compression region of the compression mechanism 121). The working fluid may be in a substantially vapor state when exiting the compression mechanism 121. A substantially vapor state can be interpreted to mean that more of the working fluid is in a vapor state than a liquid state. However, 1% to 5% of the working fluid may be in the liquid state (with the remaining amount of the working fluid being in the vapor state). As mentioned above, if any proportion of the working fluid remains in a liquid state when entering the foil bearing(s) 110 the foil bearing(s) 110 may be damaged. Accordingly, it may be advantageous to ensure that temperature of the working fluid is above its boiling point (e.g., at least 3° F. above boiling).

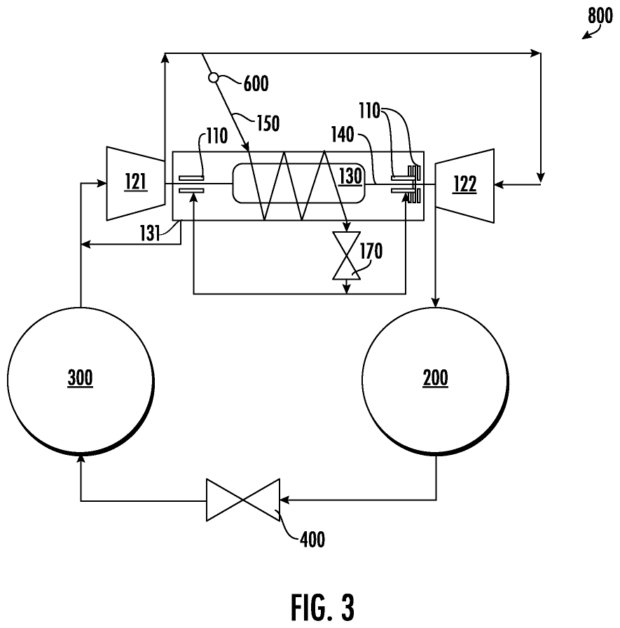

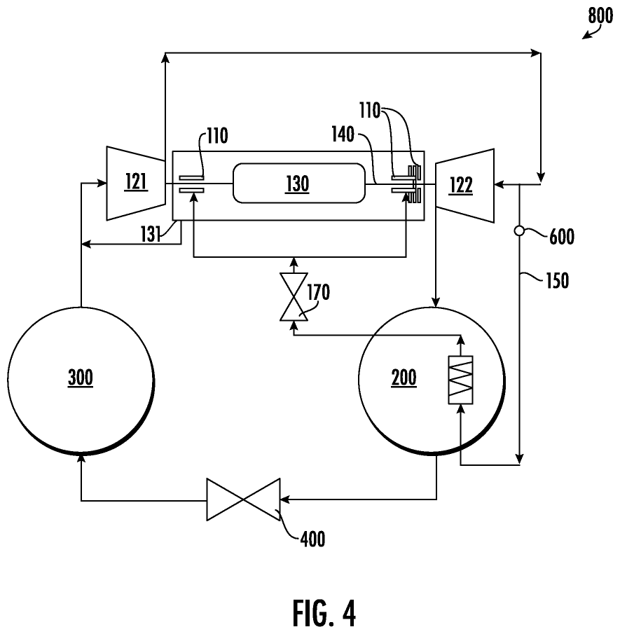

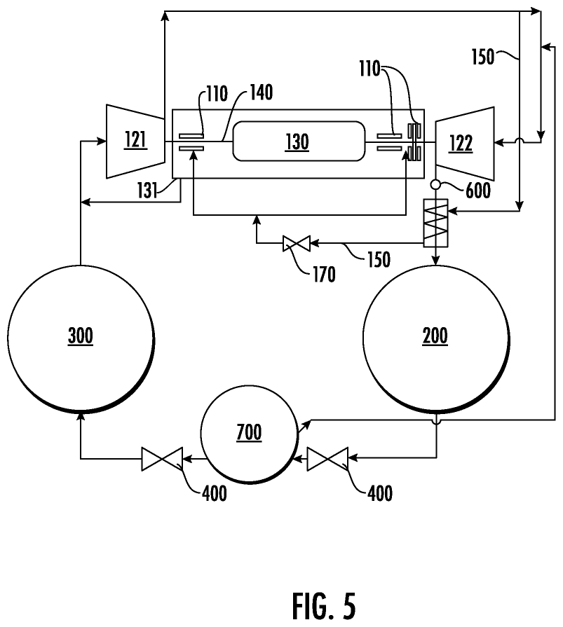

To ensure that the temperature of the working fluid is above its boiling point (e.g., by at least 3° F.), in certain instances, the working fluid must be heated (e.g., using a heating apparatus). This heating apparatus may include at least one of: an external heater 500 (as shown in FIG. 2), the motor 130 (as shown in FIG. 3), the condenser 200 (as shown in FIG. 4), and a discharge gas conduit (as shown in FIG. 5). It should be appreciated that in certain instances more than one method of heating the working fluid may be used. Regardless of how the working fluid is heated, in certain instances, the working fluid is heated between 3° F. and 7° F. of superheat.

FIG. 2 is a schematic illustration of a vapor compression system 800 including a compressor 100, a condenser 200, an expansion valve 400, and an evaporator 300, with a supply line 150 directing working fluid from a compression mechanism 121 toward the foil bearing(s) 110, where the working fluid is heated using an external heater 500. The compressor 100 shown is two-stage compressor (e.g., including both a first compression mechanism 121 and a second compression mechanism 122). It should be appreciated that the supply line 150 may, in certain instances, be in fluid communication with either or both the first compression mechanism 121 and the second compression mechanism 122. As shown, the working fluid is transferred to the compressor 100 from the evaporator 300, where it enters the first compression mechanism 121. A portion of the working fluid from the first compression mechanism 121 may be transferred (via the supply line 150) toward the foil bearing(s) 110, with the remaining amount being transferred to the second compression mechanism 122. To regulate the flow of the working fluid toward the foil bearing(s), the supply line 150 may include a valve 170. This valve 170 may be downstream of the external heater 500. In certain instances, the external heater 500 is an electric heater (e.g., consuming electricity as an energy source) or a combustion-based heater (e.g., consuming natural gas as an energy source). Once heated by the external heater 500, the working fluid is injected toward the foil bearing(s) 110. The working fluid, once used by the foil bearing(s) 110, may exit the motor 130 through a drain 131 in the motor 130. This working fluid may enter the first compression mechanism 121 along with the working fluid from the evaporator 300.

FIG. 3 is a schematic illustration of a vapor compression system 800 including a compressor 100, a condenser 200, an expansion valve 400, and an evaporator 300, with a supply line 150 directing working fluid from a compression mechanism 121 toward the foil bearing(s) 110, where the working fluid is heated using the motor 130 of the compressor 100. The compressor 100 shown is two-stage compressor (e.g., including both a first compression mechanism 121 and a second compression mechanism 122). It should be appreciated that the supply line 150 may, in certain instances, be in fluid communication with either or both the first compression mechanism 121 and the second compression mechanism 122. As shown, the working fluid is transferred to the compressor 100 from the evaporator 300, where it enters the first compression mechanism 121. A portion of the working fluid from the first compression mechanism 121 may be transferred (via the supply line 150) toward the foil bearing(s) 110, with the remaining amount being transferred to the second compression mechanism 122. To regulate the flow of the working fluid toward the foil bearing(s), the supply line 150 may include a valve 170. This valve 170 may be downstream of the motor 130. In certain instances, the supply line 150 is configured to flow working fluid close enough to (or within) the motor 130 that the working fluid can transfer heat from the motor 130. In various instances, the motor 130 may generate enough heat that the working fluid may be heated to at least 3° F. beyond its boiling point. Once heated by the motor 130, the working fluid is injected toward the foil bearing(s) 110. The working fluid, once used by the foil bearing(s) 110, may exit the motor 130 through a drain 131 in the motor 130. This working fluid may enter the first compression mechanism 121 along with the working fluid from the evaporator 300.

FIG. 4 is a schematic illustration of a vapor compression system 800 including a compressor 100, a condenser 200, an expansion valve 400, and an evaporator 300, with a supply line 150 directing working fluid from a compression mechanism 121 toward the foil bearing(s) 110, where the working fluid is heated using the condenser 200. The compressor 100 shown is two-stage compressor (e.g., including both a first compression mechanism 121 and a second compression mechanism 122). It should be appreciated that the supply line 150 may, in certain instances, be in fluid communication with either or both the first compression mechanism 121 and the second compression mechanism 122. As shown, the working fluid is transferred to the compressor 100 from the evaporator 300, where it enters the first compression mechanism 121. A portion of the working fluid from the first compression mechanism 121 may be transferred (via the supply line 150) toward the foil bearing(s) 110, with the remaining amount being transferred to the second compression mechanism 122. To regulate the flow of the working fluid toward the foil bearing(s) 110, the supply line 150 may include a valve 170. This valve 170 may be downstream of the condenser 200. In certain instances, the supply line 150 is configured to flow working fluid close enough to (or within) the condenser 200 that the working fluid can transfer heat from the condenser 200. In various instances, the condenser 200 may generate enough heat that the working fluid may be heated to at least 3° F. beyond its boiling point. Once heated by the condenser 200, the working fluid is injected toward the foil bearing(s) 110. The working fluid, once used by the foil bearing(s) 110, may exit the motor 130 through a drain 131 in the motor 130. This working fluid may enter the first compression mechanism 121 along with the working fluid from the evaporator 300.

FIG. 5 is a schematic illustration of a vapor compression system 800 including a compressor 100, a condenser 200, an expansion valve 400 on either side of an economizer 700 (e.g., which may be either a flash economizer 700 or a subcooling economizer 700), and an evaporator 300, with a supply line 150 directing working fluid from a compression mechanism 121 toward the foil bearing(s) 110, where the working fluid is heated using a discharge gas conduit (e.g., from a second compression mechanism 122). The compressor 100 shown is two-stage compressor (e.g., including both a first compression mechanism 121 and a second compression mechanism 122). It should be appreciated that the supply line 150 may, in certain instances, be in fluid communication with either or both the first compression mechanism 121 and the second compression mechanism 122. As shown, the working fluid is transferred to the compressor 100 from the evaporator 300, where it enters the first compression mechanism 121. A portion of the working fluid from the first compression mechanism 121 may be transferred (via the supply line 150) toward the foil bearing(s) 110, with the remaining amount being transferred to the second compression mechanism 122. To regulate the flow of the working fluid toward the foil bearing(s) 110, the supply line 150 may include a valve 170. This valve 170 may be downstream of the location where the working fluid is heated by the discharge gas conduit (e.g., from the second compression mechanism 122). In certain instances, the supply line 150 is configured to flow working fluid close enough to (or within) the discharge pipe of the second compression mechanism 122 so that the working fluid can transfer heat from the discharge gas conduit. In various instances, the discharge gas conduit may generate enough heat that the working fluid may be heated to at least 3° F. beyond its boiling point. Once heated by the discharge gas conduit, the working fluid is injected toward the foil bearing(s) 110. The working fluid, once used by the foil bearing(s) 110, may exit the motor 130 through a drain 131 in the motor 130. This working fluid may enter the first compression mechanism 121 along with the working fluid from the evaporator 300.

Regardless of how heated, the working fluid may be injected toward the foil bearing(s) 110 approximately continuously by the supply line 150 when the compressor 100 is operational. In certain instances, the compressor 100 is the driving force for injecting the working fluid toward the foil bearing(s) 110. Meaning that when the compressor 100 is operational the compressor 100, through generating a positive pressure, forces the working fluid toward the foil bearing(s) 110. In certain instances (e.g., when the compressor 100 is the driving force for injecting the working fluid toward the foil bearing(s) 110), the injecting of the working fluid stops when the compressor 100 is shutdown. This may be because, when the compressor 100 is shutdown there is no positive pressure being generated that would force the working fluid toward the foil bearing(s) 110. The compressor 100 may be seen as shutdown when the compressor 100 is not generating a positive pressure. The compressor 100 may be seen as being operational when the compressor 100 is generating a positive pressure.

It is envisioned that in certain instances it may not be necessary to heat the working fluid before being injected toward the foil bearing(s) 110. For example, it may not be necessary to heat the working fluid if the temperature of the working fluid is already at least 3° F. beyond its boiling point. Accordingly, the vapor compression system 800 may include at least one sensor 600 to monitor the temperature of the working fluid before it is heated (e.g., include a sensor 600 upstream of the external heater 500, motor 130, the condenser 200, and/or the discharge gas conduit from the second compression mechanism 122). This sensor 600 may include any technology capable of measuring the temperature of the working fluid. In certain instances, the sensor 600 is a temperature probe placed in the supply line 150. This sensor 600 may determine whether the temperature of the working fluid is already at least 3° F. beyond its boiling point. If the temperature of the working fluid is already at least 3° F. beyond its boiling point, the heating may be avoided (e.g., the external heater 500 may be turned off, or the working fluid may be routed by the supply line 150 to avoid the heating source (e.g., the external heater 500, motor 130, the condenser 200, and/or the discharge gas conduit from the second compression mechanism 122).

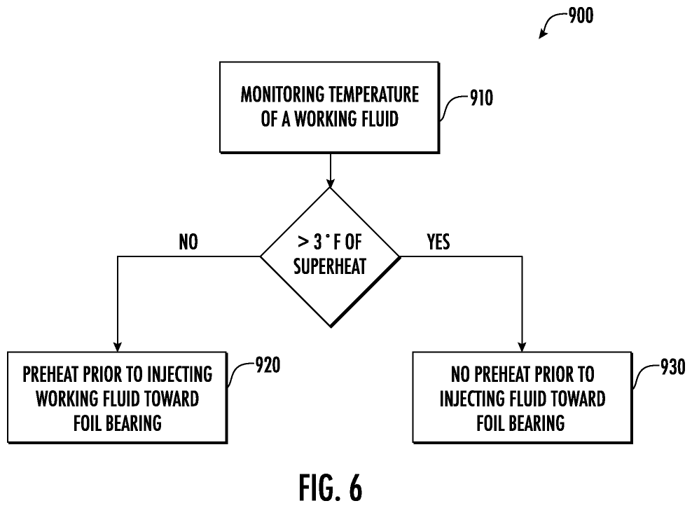

An exemplary method 900 of operating a vapor compression system 800 is illustrated in FIG. 6. The method 900 may be performed, for example, using the exemplary vapor compression system 800 shown in FIGS. 2-5, which may include the exemplary compressor 100 shown in FIG. 1. As shown in FIG. 1, the compressor 100 may include a foil bearing 110 for supporting a rotating shaft 140 and a compression mechanism 121 for increasing a pressure of a working fluid. The method 900 provides step 910 for monitoring a temperature of the working fluid downstream of the compression mechanism 121. If the working fluid has less than 3° F. of superheat, the method 900 provides for the heating of the working fluid before being injected toward the foil bearing 110. If the working fluid has greater than 3° F. of superheat, the method 900 provides step 920 of not heating the working fluid before being injected toward the foil bearing 110. As described above, the working fluid may be heated by at least one of: an external heater 500, the motor 130, the condenser 200, and a discharge gas conduit (e.g., from the second compression mechanism 122). In certain instances, the working fluid is heated to between 3° F. and 7° F. of superheat. This heating of the working fluid may ensure that all of the working fluid is in a vapor state prior to being injected in the foil bearing 110, which may help to prevent the foil bearing(s) 110 from becoming damaged.

The use of the terms “a” and “and” and “the” and similar referents, in the context of describing the invention, are to be construed to cover both the singular and the plural, unless otherwise indicated herein or cleared contradicted by context. The use of any and all example, or exemplary language (e.g., “such as”, “e.g.”, “for example”, etc.) provided herein is intended merely to better illuminate the invention and does not pose a limitation on the scope of the invention unless otherwise claimed. No language in the specification should be construed as indicating any non-claimed elements as essential to the practice of the invention.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A compressor assembly comprising:
a motor for driving a rotating shaft;
a foil bearing for supporting the rotating shaft;
a compression mechanism for increasing a pressure of a working fluid, the compression mechanism connected to the rotating shaft;
a supply line in fluid communication with the compression mechanism, the supply line configured for injecting the working fluid toward the foil bearing when the compressor is operational; and
a heating apparatus in fluid communication with the supply line, wherein the heating apparatus is configured to heat the working fluid prior to being injected toward the foil bearing.

2. The compressor assembly of claim 1, wherein the supply line is configured downstream of the compression mechanism.

3. The compressor assembly of claim 1, further comprising at least one sensor disposed in the supply line upstream of the heating apparatus, the at least one sensor configured to monitor a temperature of the working fluid.

4. The compressor assembly of claim 1, wherein the heating apparatus is configured to heat the working fluid between 3° F. and 7° F. of superheat.

5. The compressor assembly of claim 1, wherein the heating apparatus comprises at least one of: an external heater, the motor, a condenser, and a discharge gas conduit.

6. The compressor assembly of claim 1, wherein the working fluid comprises a refrigerant.

7. A vapor compression system comprising:
a condenser for transferring heat from a working fluid to an external fluid medium; and
a compressor assembly in fluid communication with the condenser, the compressor assembly comprising:
a motor for driving a rotating shaft;
a foil bearing for supporting the rotating shaft;
a compression mechanism for increasing a pressure of a working fluid, the compression mechanism connected to the rotating shaft;
a supply line in fluid communication with the compression mechanism, the supply line configured for injecting the working fluid toward the foil bearing; and
a heating apparatus in fluid communication with the supply line, wherein the heating apparatus is configured to heat the working fluid prior to being injected toward the foil bearing.

8. The vapor compression system of claim 7, further comprising at least one sensor disposed in the supply line upstream of the heating apparatus, the at least one sensor configured to monitor a temperature of the working fluid.

9. The vapor compression system of claim 8, wherein the working fluid is heated only when the working fluid comprises less than 3° F. of superheat.

10. The vapor compression system of claim 7, wherein the supply line is configured downstream of the compression mechanism.

11. The vapor compression system of claim 7, wherein the heating apparatus is configured to heat the working fluid to between 3° F. and 7° F. of superheat.

12. The vapor compression system of claim 7, wherein the heating apparatus comprises at least one of: an external heater, the motor, the condenser, and a discharge gas conduit.

13. The vapor compression system of claim 7, wherein the external fluid medium is comprised of at least one of: an air supply and a water supply.

14. The vapor compression system of claim 7, wherein the working fluid comprises a refrigerant.

15. A method of operating a vapor compression system comprising a compressor and a condenser, the compressor comprising a foil bearing for supporting a rotating shaft and a compression mechanism for increasing a pressure of a working fluid, the method comprising:
monitoring a temperature of the working fluid downstream of the compression mechanism; and
injecting at least a portion of the working fluid from the compression mechanism toward the foil bearing, wherein the working fluid is heated prior to being injected toward the foil being when the working fluid comprises less than 3° F. of superheat.

16. The method of claim 15, further comprising injecting the working fluid approximately continuously from the compression mechanism.

17. The method of claim 15, further comprising heating the working fluid to between 3° F. and 7° F. of superheat.

18. The method of claim 17, further comprising heating the working fluid with at least one of: an external heater, the motor, the condenser, and a discharge gas conduit.

19. The method of claim 15, wherein the working fluid comprises between 1% and 5% liquid prior to being heated.

20. The method of claim 15, wherein the working fluid comprises a refrigerant.
